(19) United States
(12) Patent Application Publication
(10) Pub. No.: US 2006/0255168 A1
(43) Pub. Date: Nov. 16, 2006

(54) Atomizing nozzle for an atomization device

(76) Inventors: Chuan-Pan Huang, Tainan City (TW); Chen-Lung Huang, Tainan City (TW)

Correspondence Address: J.C. Patents, Suite 250, 4 Venture, Irvine, CA, 92618, US

(21) Appl. No.: 11/116,619

(22) Filed: Apr. 27, 2005

(51) Int. Cl. F21S 8/00

(52) U.S. Cl. 239/18; 239/71; 239/211; 362/96

(57) ABSTRACT

An atomization device comprises a main body with atomization room where a nebulizer was designed. An atomizing nozzle is positioned on top of the atomization room. A decoration light is designed at the jetting tube of the atomizing nozzle. The atomized liquid spurted from the jetting tube is shined by means of the light beam projected by the decoration light to show the dynamic state of the jetted atomized liquid. Therefore, an atomization device with the virtue of good decoration and being practical can be obtained.

### FIELD OF THE INVENTION

The present invention provides an atomizing nozzle for an atomization device, particularly an atomizing nozzle at the top of an atomization room of main body, wherein a decoration light is designed at the jetting tube of the atomizing nozzle, the atomized liquid jetted from the jetting tube is shined by means of the projecting light beam of the decoration light to show the dynamic state of jetted atomized liquid. Therefore, an atomizing device with the virtue of good decoration and being practical can be obtained.

### BACKGROUND OF THE INVENTION

According to the prior humidistat (or atomization device), as disclosed in U.S. Pat. No. 4,643,351, a ultrasonic oscillator 15 is used as a nebulizer of the humidistat. After a colorless liquid is atomized by the nebulizer, it would be spurted by the atomizing nozzle at the top of atomization room. However, because there is no obvious visual effect observed when the colorless atomized liquid is spurted in a room, it is difficult for a user, unable to observe the colorless atomized liquid, to know whether the atomization device operates normally. In the case of that the user does not know whether any liquid is available in the atomization device but starts the atomization device, the safety problem for no loading operation would occur. Although a safety-monitoring device is available for most atomization devices, it is inevitable that danger will occur at any time for the user's ignorance in the case of damaged safety-monitoring device.

For this purpose, the inventor of the present invention researched existing atomization devices and invented this invention aiming at overcoming the structure deficiencies of the conventional atomization devices.

### SUMMARY OF THE INVENTION

One purpose of the present invention is to provide an atomization device, which can monitor whether a liquid is available in the atomization device according to the spraying state of the liquid for user's safety.

Another purpose of the present invention is to provide an atomization device with a decorative function. When the atomization device spurts the atomized liquid, a projecting light beam generated from a decoration light provided at a nozzle will shoot the front of the nozzle; accordingly, the user will know the atomizing state. Additionally good decoration appearance would be obtained.

The present invention has the following features:

1. The atomizing nozzle of the present invention is designed at the top of an atomization room of the atomization device, and a decoration light is designed at a jetting tube of the atomizing nozzle, the atomized liquid spurted from the jetting tube is shined by means of the projecting light beam of the decoration light to show the dynamic state of the jetted atomized liquid. Therefore the atomizing device with the virtue of good decoration and being practical can be obtained.

2. In the atomizing nozzle of the present invention, the projecting light source from the decoration light at the jetting tube can be used to form a light beam to shine the atomized liquid so as to show its dynamic jetting state and enhance its decoration aesthetic feelings.

3. In the atomizing nozzle of the present invention, an optical fiber channel for focusing light can be designed at the front side of the decoration light, which has light gathering function, so that the good light gathering effect for forming light beam would be increased, further aesthetic feelings would be enhanced.

### BRIEF DESCRIPTION OF DRAWINGS

FIG. 1 is a sectional view of embodiment one of the present invention.

FIG. 2 is a sectional view of embodiment 1 of the present invention during operation.

FIG. 3 is a sectional view of embodiment 2 of the present invention.

FIG. 4 is a sectional view of embodiment 3 of the present invention.

FIG. 5 is a sectional view of embodiment 4 of the present invention.

FIG. 6 is an exploded view of embodiment 5 of the present invention.

### DESCRIPTION OF PREFERRED EMBODIMENTS

Therefore, for better understanding of the present invention, details descriptions of the present invention in connection with the drawings are given as follows:

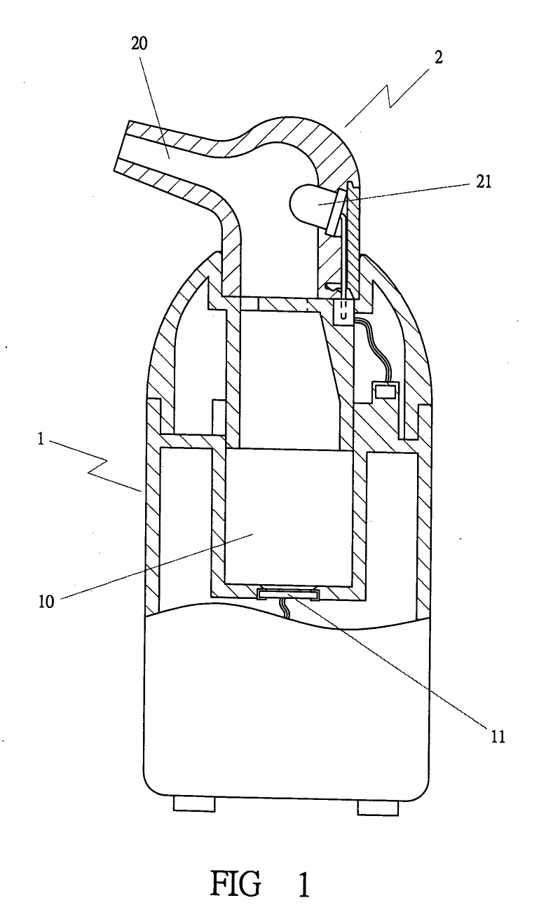

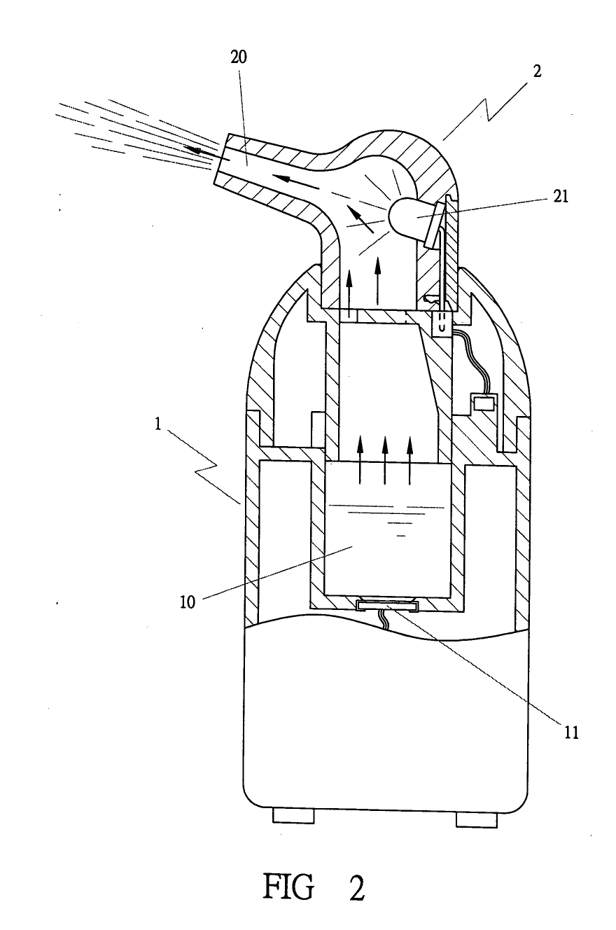

As shown in FIGS. 1 and 2, it is the embodiment 1 of atomization device of the present invention. The atomization device comprises:

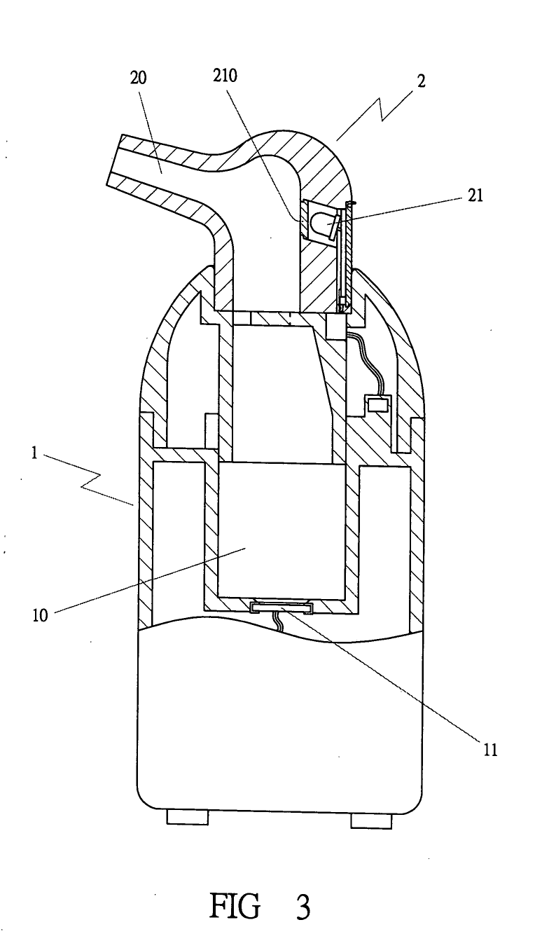

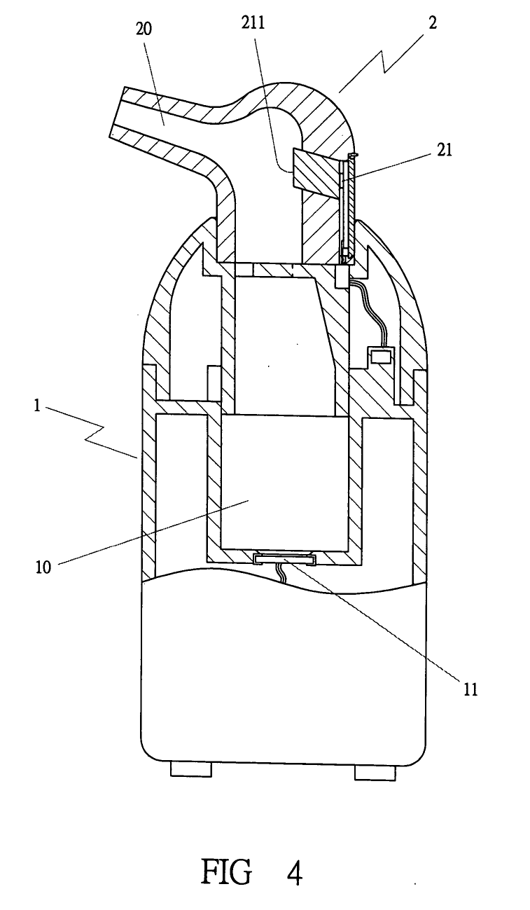

A main body 1 with an atomization room 10 where partial liquid or atomized liquid is stored, and a nebulizer 11 is designed in the atomization room 10, which can comprise a heater or a ultrasonic oscillator. Additionally, an atomizing nozzle 2 is designed at the upper end of the atomization room 10. The atomization nozzle 2 has a jetting tube 20 for the atomized liquid where a decoration light 21 is designed, and the decoration light 21 can generate a projecting light source (as shown in FIG. 2), and optionally a light mask 210 (as shown in FIG. 3) or an optical fiber channel 211 (as shown in FIG. 4) can be designed at the front side of decoration light 21. The light mask 210 and the optical fiber channel can be used to gather and focus the light well. Accordingly, after the nebulizer 11 atomizes the liquid, the atomized liquid would be spurted by the atomizing nozzle through the jetting tube 20, and the light beam from the decoration light will light the atomized liquid spurted from the jetting tube 20 of the atomizing nozzle 2. Additionally not only the atomized liquid jetted from the jetting tube 20 of the atomizing nozzle 2 and shined on by the light beam will show the dynamic state of the jetted atomized liquid but also can generate good interior decoration and enhance utility value of the atomization device.

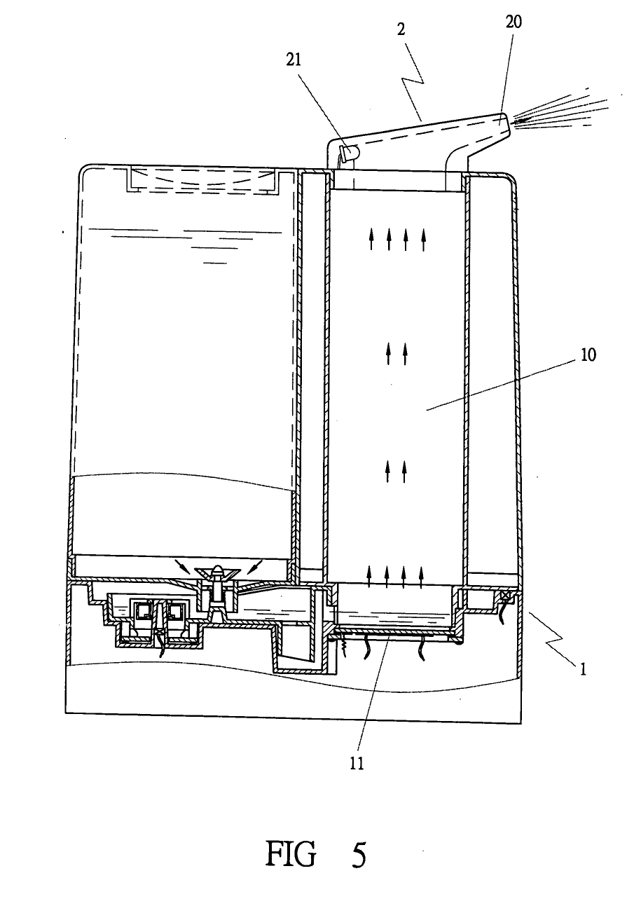

FIG. 5 shows the embodiment 4 of the present invention. Although the appearance and the structure of the atomization device of the embodiment 4 and that of the embodiment 1 are a little different, the structure of atomizing nozzle is the same or similar in the embodiments 1 and 4, i.e. a decoration light 21 is designed at the jetting tube 20 of the atomizing nozzle 2, which has same function comparing with the embodiment 1. It follows that the present invention is not limited to any specific shape and structure of an atomization device. Indeed, the atomizing nozzle of the present invention can be used in any suitable atomization devices.

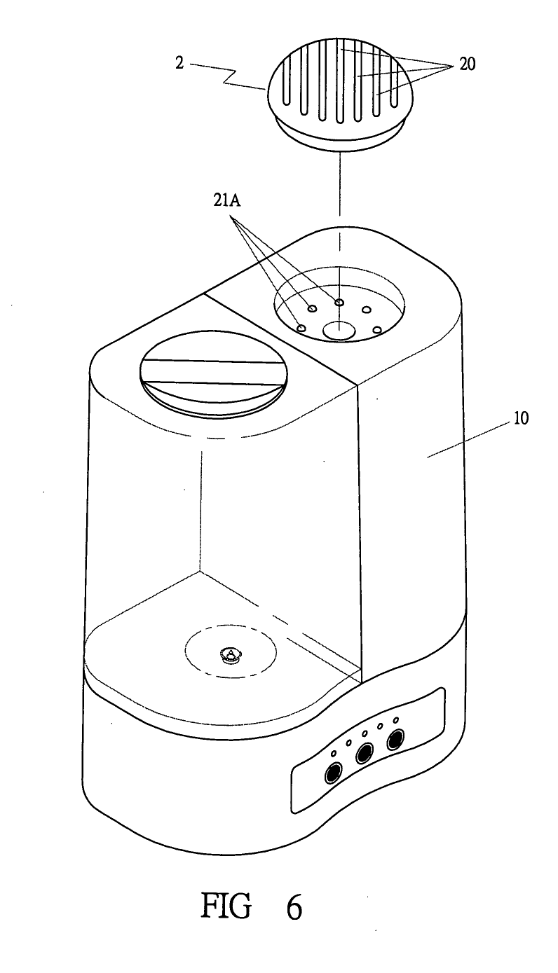

FIG. 6 shows the embodiment 5 of the present invention. Although the structure and appearance of the atomization device of the embodiment 5 and that of the embodiments 1 and 4 are a little different, they have similarities. One or more decoration lights 21A are designed under the atomizing nozzle 2, i.e. on top of the atomization room 10. When the atomized liquid is spurted from the jetting tube 20 of the atomizing nozzle 2, similar decoration and utility effects as that of the embodiments 1 and 4 would be obtained by means of the light beam from the decoration lights 21A.

According to the present invention, the decoration light can be positioned inside or outside the atomizing nozzle, on top of the atomization room, or other suitable locations of the atomization device. One or more decoration lights can be used for suitable applications.

What the claimed is:

1. An atomizing nozzle for an atomization device, the atomization device comprising a main body with an atomization room, the atomizing nozzle being in fluid communication with the atomization room and comprising a jetting tube for jetting an atomized liquid from the atomization room, and a decoration light for shining a light beam on the atomized liquid jetted from the jetting tube.

2. The atomizing nozzle, as recited in claim 1, wherein an optical fiber channel is designed at the front side of the decoration light.

3. The atomizing nozzle, as recited in claim 1, wherein a light mask is designed at the front side of the decoration light.

4. The atomizing nozzle, as recited in claim 1, wherein the decoration light is positioned on top of the atomization room of the main body.

5. The atomizing nozzle, as recited in claim 1, wherein the decoration light is positioned in the atomizing nozzle.

6. An atomization device comprising:
a main body with an atomization room;
an atomizing nozzle in fluid communication with the atomization room, wherein the atomizing nozzle comprises a jetting tube for jetting an atomized liquid from the atomization room;
a decoration light for shining a light beam on the atomized liquid jetted from the jetting tube.

7. The atomization device, as recited in claim 6, wherein an optical fiber channel is designed at the front side of the decoration light.

8. The atomization device, as recited in claim 6, wherein a light mask is designed at the front side of the decoration light.

9. The atomization device, as recited in claim 6, wherein the decoration light is positioned on top of the atomization room of the main body.

10. The atomization device, as recited in claim 1, wherein the decoration light is positioned in the atomizing nozzle.
